(19) United States
(12) Patent Application Publication
(10) Pub. No.: US 2016/0289046 A1
(43) Pub. Date: Oct. 6, 2016

(54) PERMANENT MAGNETIC DEVICE

(71) Applicant: MAGSWITCH TECHNOLOGY INC., Lafayette, CO (US)

(72) Inventors: David H. Norton, Westminster, CO (US); Yiwei Yan, Westminster, CO (US)

(21) Appl. No.: 15/036,548

(22) PCT Filed: Nov. 17, 2014
(86) PCT No.: PCT/IB2014/066085

§ 371 Date: May 13, 2016

Related U.S. Application Data
(60) Provisional application No. 61/904,613, filed on Nov. 15, 2013.

(51) Int. Cl. B66C 1/04; H01F 7/02; H01F 7/04

(52) U.S. Cl. CPC B66C 1/04; H01F 7/04; H01F 7/021

(57) ABSTRACT

A magnetic device (100) for lifting and/or holding ferromagnetic work-pieces comprises a ferromagnetic housing block (10) and a switchable magnet arrangement accommodated within a cavity of the housing block (10). The housing (10) is formed to define two longitudinal sides that are substantially decoupled magnetically from one another. The switchable magnet arrangement comprises a series of interleaved dipolar magnet units (40, 42) arranged along a longitudinal axis of the housing block (10) between the two sides. The magnet units (40, 42) comprise a series of fixed permanent magnets (40) and rotatable permanent magnets (42) that are cylindrical, or more particularly annular in shape, and traversed by an actuation shaft (24) that rotates the rotatable magnets (42) with respect to the fixed magnets (40) about the longitudinal axis of the housing block (10). The magnet units (40, 42) can thus be switched between an ‘off’ position in which respective magnetic fields are opposed and substantially cancel each other, and an ‘on’ position in which respective magnetic fields are aligned and substantially reinforce each other.

### FIELD OF THE INVENTION

The present invention relates generally to material handling, and in particular to magnetic holding and lifting devices used in securing ferromagnetic objects such as work-pieces, including steel plates, blocks, etc, for machining, lifting, handling, conveying and other operations.

In particular, the invention relates to switchable magnetic devices which use permanent magnets as the sole source of magnetic flux for securing a workpiece to a working face of the device. However, servo motors (electric, pneumatic, hydraulic) may be used in switching the device between activated and deactivated states, instead of purely manual mechanical operation.

### BACKGROUND TO THE INVENTION

Permanent and electromagnetic lifting tools and devices have been used for many years in the field of ferromagnetic materials handling.

Magnetic lifting devices that utilise permanent magnets as the sole source for generating a coupling force between device and a work piece are known, for example from U.S. Pat. Nos. 3,009,727, 3,389,356, 3,452,310, 4,324,219, 5,382,935 and 5,435,613 and US patent publication 2003/0146633 A1.

One particular type of magnetic ‘heavy lifter’ is supplied by Magswitch Industrial Solutions of Westminster, Colo., United States of America, under the MLAY product range. As an example, one may refer to the Magswitch MLAY 600×4 Lifting Magnet. These lifters use switchable permanent magnets as the source of magnetic flux for securing ferromagnetic objects to a working face of the device. U.S. Pat. No. 7,012,495, the content of which is hereby incorporated by reference, describes the underlying principle that finds modified implementation in MLAY lifting devices. In the US patent, a pair of stacked cylindrical, diametrically magnetised permanent magnets, one of which is rotatable about the stacking axis, is received between ferromagnetic (passive) pole extension pieces which provide the housing and working face of such switchable unit. A MLAY-type device is described and illustrated in patent document WO/2013/179126 A1, the content of which is also incorporated herein by way of short hand cross-reference. The MLAY 600×4 essentially comprises a series of four discrete pairs of stacked cylindrical, diametrically magnetised permanent magnets arranged side-by side within a common housing block that provides the pole extension pieces for all four magnet pairs, with the stacking axes of the magnet pairs extending parallel to one another and perpendicular to a longitudinal axis or the housing.

Operationally, the MLAY 600×4 is manually switchable between respective off and on positions, to selectively deliver a negligible or a substantial magnetic flux from the four pairs of magnets via two ferromagnetic pole shoe bars secured to a lower face of the housing and thus provide the working face at the base of the housing of the device. As permanent magnets are used, and the device is manually switched, no external source of electricity is required. A pair of clevis fasteners are mounted to the housing and allow the magnetic lifter, and an attached workpiece, to be hoisted using a crane boom or similar device.

The MLAY series of heavy lifters have a brick-like housing comprising a body of magnetisable ferromagnetic material. The body has a series of identical bores (four, in the case of MLAY 600×4) extending vertically through the housing body in closely adjacent alignment along the length of the housing, separated by a narrow web of housing material, which is treated so as to be non-magnetisable.

Each bore accommodates a pair of stacked cylindrical magnets—namely an upper magnet and a lower magnet. Both upper and lower magnets are diametrically polarised, rare-earth permanent dipole magnets.

The lower magnets are fixed in place, and the upper magnets can rotate within the bores. The lower openings of the bores are sealed off flush with the lower face of housing by shunt disks (having high magnetic reluctance) to prevent ingress of contaminants and flux leakage paths. The upper and lower magnets are separated by a friction-reducing separator sheet sandwiched between the stacked magnets, to facilitate easy rotation.

The lower magnets are fixed against rotation and oriented such that their N-S pole axes extend perpendicular to the longitudinal axis of the housing. In other words, the diameter lines which separate the N and S poles of each lower magnet are aligned with one another along the longitudinal symmetry plane of the housing body.

The upper magnets are free to rotate within their bores, and are actuated by an actuator subassembly, which allows synchronous switching of all the upper magnets between specific off and on positions. The actuator subassembly use a rack and pinion arrangement that provides for co-ordinated and synchronized rotation of each of the upper magnets by a handle at one end of the housing.

When the lifter is in an ‘off’ position, the poles of the upper magnets are oppositely arranged to those of the lower magnets below. That is, the N poles of the upper magnets overlie the S poles of the lower magnets, and vice-versa.

Accordingly, in this arrangement, upper and lower magnets act as an internal active magnetic shunt, and as a result the external magnetic field strength approaches zero, as the fields come close to cancelling each other owing to their close proximity. No magnetic flux will be available for ‘tapping’ at the pole shoe bars defining the working or engagement face of the device.

Rotating the upper magnets through 180° about their axes of rotation brings the device into an cony position, in which the polar orientation of the upper and lower magnets is aligned. That is, the N poles of the upper and lower magnets overlie each other, as do the S poles. The magnetic fields of the lower and upper magnets thus reinforce each other, and the external magnetic field is quite strong. As a consequence, magnetic flux can be ‘tapped’ by bringing a work piece into contact across the pole shoe bars, which provide a low reluctance path for flux transfer into and through the attached workpiece, whereby a closed magnetic circuit is created

One particular issue that arises in connection with the MLAY 600×4 and other permanent magnet lifting/holding devices is residual magnetisation (remanence) imparted to a ferromagnetic work-piece following attachment to and releasing from the device. It is difficult to avoid residual magnetisation entirely as a consequence of magnetic coupling between work piece and device in existing designs, though minimal ‘magnetic’ disturbance of the work-piece is recognised as a desirable goal.

From the above description it will be furthermore appreciated that devices such as the MLAY magnetic grabs (as well as others mentioned above), can be modified by removing the components devised for coupling the device's housing to a hoisting/lifting apparatus, thus providing a stationary magnetic chuck or work-piece holding device wherein the permanent magnets are switchable to provide flux access at one or more work-piece receiving surfaces provided by the pole shoe bars or other magnetically polarisable engagement components at the housing.

Furthermore, there are many types of dedicated magnetic holding device/chuck designs known in the prior art, for example as illustrated and described in U.S. Pat. Nos. 5,266,914, 4,468,648, 4,419,644, which use permanent magnets that are displaceable relative to one another to effect switching of the device between a magnetic flux delivering on state and an off-state where no magnetic flux is ‘available’ at the working face of the device, some of which are characterised by a complex make-up of the device overall.

The potential for residual magnetisation remaining in the work-piece after machining or other operations have been carried out is in some instances a problem, which requires the work-piece to undergo separate degaussing measures.

In light of the above described residual magnetisation, it would thus be advantageous to provide a switchable permanent magnet device, which may be devised as a magnetic chuck, lifting device, coupling device and similar, which minimises remanence in a ferromagnetic work-piece after it has been released from magnetic interaction with the device.

### SUMMARY OF THE INVENTION

One object of the present invention is to provide a magnetic device for releasable coupling with a ferromagnetic object, such as a work piece, that minimises residual magnetism in the workpiece following attachment and release by/from the device.

It is another object to provide a magnetic lifting or a magnetic holding device, in particular using exclusively permanent magnets, which is simplified from a constructional stand point, in particular as regards switching the device on and off.

Other aims and objects will become apparent from the ensuing description.

The inventive concept of the present invention resides in a recognition that an improved magnetic device can be achieved by providing a switchable magnetic arrangement in which a plurality of permanent magnet units, preferably dipole permanent magnets, are arranged along a common axis in such manner that some of the magnet units (and thus the N-S pole pairs which permanent magnets have) are rotatable with respect to stationary magnet units interleaved between the rotatable units, and wherein the arrangement is switchable between off and on positions by relative rotation of the rotatable units with respect to the stationary units arranged about the common axis to cause the rotatable N-S pole pairs of the rotatable magnet units to be parallel or anti parallel with those of the stationary magnet units. This arrangement is found to provide ease of construction, as well as a relatively lower and more even pattern of residual magnetization compared to alternative prior art devices, when the magnetic arrangement is received in a common bore (or otherwise shaped cavity) and surrounded by ferromagnetic wall parts of a housing, wherein the wall parts provide fixed pole extension elements for the stationary magnet units and the rotatable magnet units, with the wall parts being either uniformly magnetised with a N- or S-polarity or having a succession of closed magnetic flux path loops between adjoining magnet units, effectively cancelling each other out, as a function of the rotational displacement of the permanent magnet units with respect to each other.

According to a first aspect of the present invention there is provided a magnetic device, comprising: a housing block with a cavity extending along a longitudinal axis thereof and having at least two ferromagnetic wall portions along a longitudinal extension of the housing block that are substantially magnetically separated from one another; a switchable permanent magnet arrangement accommodated within the cavity of the housing block for magnetically interacting with the ferromagnetic wall portions; and a working face extending along one or more of an exterior longitudinal side, top or bottom face of the housing at the least two magnetically separated wall portions of the housing block, the working face devised for attaching to a ferromagnetic object for magnetically securing the object in releasable manner to the device, characterised in that the switchable permanent magnetic arrangement comprises a plurality of permanent magnet units in interleaving, successive arrangement about and along a rotor axle extending within the cavity, wherein alternate ones of the interleaving permanent magnet units are secured to the axle for rotation therewith whereas the remainder are traversed by the axle and held stationary within the cavity such as to impart opposite N-S polarities on the at least two ferromagnetic wall portions of the housing, and in that the rotatable permanent magnet units are secured to the rotor axle in such manner that a N-S pole pair thereof may be brought in or out of parallel and anti-parallel alignment with a N-S pole pair of the adjoining stationary permanent magnet units, indexing being such that the device is switchable between an on, magnetic flux delivering position and an off, magnetic flux shunting position, by rotating the axle-secured magnet units within the cavity with respect to the interleaved stationary magnet units.

Whilst preferred embodiments of the invention utilize dipole permanent magnet units, and more particularly unitary (or single piece) dipole cylindrical or disk-plate permanent magnet bodies (as compared to magnet rotor unit assemblies comprising active and passive magnetic material), it will be understood that quadrupole magnet rotors may also be used. In such case, the housing block will require the presence of four, magnetically separated wall portions instead of two, whereby in the case of a quadrilateral cross-section housing block, the housing will have four working faces that can be selectively magnetised and demagnetised as a function of the rotational position of the rotor magnet units vis a vis the stationary magnet units.

It will be understood that the number of individual magnet units in the device and the rating of these will depend on the specification and use of the device. For example, the device may have four rotatable and three stationary magnets, each magnet having a diameter of 50 mm and thickness of about 20 mm with exception of the center fixed magnet which has double the thickness (ie extension in longitudinal direction of the housing), which would provide approximately 16000 Newton holding force, where the magnets are NdFeB rare earth magnets.

Preferably, the series of interleaved, dipolar permanent magnet units are arranged to extends co-axial with the longitudinal axis of the housing block, the permanent magnet units being rotatable relative to each other about the longitudinal axis of the housing block between an ‘off’ position in which respective magnetic fields are opposed and substantially cancel each other, and an cony position in which respective magnetic fields are aligned and substantially reinforce each other, whereby in the on position common poles of the magnet units are respectively arranged along opposed longitudinal sides of the housing block, and the magnetic device can firmly attach to it a ferromagnetic work-piece by virtue of magnetic flux delivered by the switchable permanent magnet arrangement via the pole faces, and in the off position will detach from the ferromagnetic work-piece.

In the on position, common poles of the dipole permanent magnet units are respectively arranged along longitudinal ferromagnetic side wall portions at opposite sides of the housing block, ie all North poles of the permanent magnet units will face the same side, whereas all South poles will face the opposite way, so that a substantial magnetic flux is delivered from the magnet units through the side wall portions though the work-piece engagement working face of the housing block to the ferromagnetic work-piece.

Preferably, a pair of ferromagnetic pole extension rails running along the longitudinal extension of the housing block can be mounted in releasable manner to the working face(s) such as to be polarised in accordance with the polarity imparted onto the wall portions at the working face. The cross-section of the pole extension rails can be selected to provide an optimal contact surface between work piece and the magnetic device, minimise air gap flux leakage and serve to compress flux.

The work-piece, when attached across the pole rails, offers a low reluctance path (relative to the surrounding air) for the magnetic flux delivered from the magnet units through the wall portions, thus forming a closed magnetic circuit with the pole-aligned permanent magnet units which closes the flux loop between the pole rails and the magnet units.

The alternating series of interleaving fixed and rotatable magnet units is preferably ‘bracketed’ by rotatable magnet units, which flank the other magnet units at respective longitudinal ends of the housing block. In other words, rotatable magnet units are located at both longitudinal terminal ends of the alternating series of fixed and rotatable magnet units.

The rotatable magnet units are preferably secured to a common actuating shaft (ie the rotor axle) using, for example, a pin and keyway arrangement, wherein the shaft extends and passes through appropriately sized through holes in the fixed magnet units which are fixed against movement within the housing block.

In its simplest iteration, the actuating shaft can be keyed directly to a handle or other type of manual operating lever or knob located and carried at an end cap or plate at one of the longitudinal terminal ends of the brick-like (regular parallelepiped) housing block, and which can be rotated though a half-revolution (ie 180 degrees) to switch between the on and off positions of the magnetic device. The rotatable magnet units are aligned on the shaft and by virtue of the actuating shaft rotate synchronously. Collectively, the rotatable magnet units in effect form a single rotor as a consequence of fixed and coincident rotation of each of the rotatable magnet units, whereby these interact magnetically with the fixed magnets located in interleaving arrangement between the rotatable magnets and the ferromagnetic wall portions surrounding the cavity (ie bore) in which the rotor is supported. This arrangement obviates the need for individual handles/shafts for switching/actuating the units. It also allows for a simplified housing design, with a single through bore providing the cavity for housing all of the magnet units.

An actuation assembly and an end support assembly are preferably mounted to the housing block and disposed at opposite longitudinal ends thereof for coupling and retaining the actuating shaft, and ensuring the actuating shaft remains centred, and thus able to freely rotate within the cylindrical housing block cavity. As previously noted, a manually-operated external handle may form part of the actuation assembly for switching between the on and off positions, although pneumatic, hydraulic or electric actuators may be employed instead.

The handle is preferably attached to the shaft via a direct coupling, but if desired, a gearing assembly may form part of the actuating assembly for coupling the handle with the actuating shaft. The handle may be operated through a restricted sweep (for example, 45°) and a gearing multiple (for example 4:1) can be used to achieve the half revolution required for switching between off and on positions. An epicyclic gearing arrangement could be used for this purpose.

Preferably, a selectively engagable rotation stop element can be provided at the housing block to arrest rotation of the actuation handle or the shaft in a selectable rotational position between the on and off positions of the device. This will allow the device to be ‘magnetised’ and operated with less than maximum magnetic flux output, if desired. The stop element may also be devised as a safety element to prevent inadvertent actuation of the handle and turning the device into its ‘off state’ when a work piece is carried during a lifting/conveying operation.

As noted, the magnetic device can be implemented as a magnetic lifting device or a magnetic work-piece holding apparatus. In one embodiment, both devices may have essentially the same external box-like housing block configuration but for the presence of a suitable arrangement or components for detachable coupling of the housing (device) to a hoisting crane, gantry or similar. The housing block will advantageously be provided with suitable mounts (such as threaded bores) to fix lifting members by way of which the device can be hoisted. In its simplest form, the lifting member(s) may comprise a rouse. Quick-change couplings could equally be mountable to the housing, to facilitate ease of mounting/coupling the lifting device to the hoisting arm of a robot, cable of a crane, or the like.

The lifting components are preferably mounted to an upper exterior face of the housing block, and the lower exterior face will provide the work-piece engagement face.

The lifting coupling components can be removed from the housing to transform the lifting device into a box-like work-piece holding device, whereby the upper exterior face of the housing block can then also provide an (additional) work-piece engagement zone. Of course, dedicated holding device configurations without mounts for lifting elements can be provided too, providing a versatile device with multiple work-piece engagement surfaces about the housing.

The square or rectangular cross-section housing block is preferably machined from a single piece of ferromagnetic material with very high magnetic susceptibility and low remanence and coercivity, eg 1018 steel, with small top and bottom webs of material about the cylindrical central cavity between opposite longitudinal side walls with substantive thickness of the housing block forming high reluctance zones which effectively magnetically ‘decouple’ the opposite longitudinal sides from one another. In other words, the opposite top and bottom sides of the housing are machined (or otherwise finished) to a thickness which prevents an undesirable magnetic circuit forming between the opposite lateral sides (ie through the housing itself), which would reduce the strength of an external circuit through the work-piece.

Alternatively, the housing block can be assembled from two housing pieces jointed with a diamagnetic gasket or gaskets to provide a similar effect of magnetically decoupling the two longitudinal sides of the housing block, thereby preventing magnetically short-circuiting the housing.

As noted, the magnet units of the device are preferably single-piece permanent di-pole magnets, but could be equally assembled from multiple permanent magnets and associated ferromagnetic passive pole pieces thereby forming a permanent magnetic dipole structure, although quadrupole (or multipole) structures can also be accommodated. In the latter case, however, use of such multi-pole magnet units will then have a bearing on the layout of the actuating mechanism required to effect relative rotation to bring the magnet units into like-polar and anti-polar alignment.

Anti-friction platelets can advantageously be located between opposing faces of rotatable and fixed magnets, in particular to prevent the magnets from seizing together in the on position where like poles are aligned axially.

Preferably, the magnet units are generally circular disk or cylindrical in shape, and more particularly annular in shape so as to define a central void to accommodate the actuation shaft. Fixed and rotatable magnet units are preferable of similar active magnetic material volume, eg using NdFeB or other rear earth magnet materials, and are mounted to be located directly adjacent to each other (with optional, very thin interleaving anti-friction disks) along the longitudinal axis of the housing block, with the actuating shaft extending through rotatable and fixed magnet units alike. It will be understood that the total active magnetic mass of the fixed and rotatable magnet units is comparable (equal) to one another to achieve a fully-off state.

Comparison of a prototype magnetic device in accordance with the present invention with a MLAY magnetic grab of same specifications (as regards the total mass of permanent magnets present in the devices and similar volume of ferromagnetic housing material) in tests have shown that the rotor-stator configuration as per the present invention results in a substantial lower magnetic remanence in a ferromagnetic plate (work-piece) after the devices have been turned off after the devices have been held magnetically attached to the workpiece for a given period of time.

The above and other objects and further scope of applicability of the present invention, in its different embodiments, will become apparent from the detailed description of preferred embodiments that follows below. However, it should be understood that the detailed description and illustrated embodiments of the invention in the accompanying drawings are not exhaustive and limiting, since variations and modification that do not depart from the broad inventive concept identified in the claims, and which will become apparent to the skilled reader in the art of the present invention, are possible.

### BRIEF DESCRIPTION OF THE DRAWINGS

FIG. 1 is a side elevation of a magnetic lifting device incorporating a switchable magnet arrangement according to an embodiment of the present invention;

FIG. 2 is an end elevation of the magnetic lifting device of FIG. 1;

FIG. 3 is a schematic sectional view of the magnetic lifting device of FIG. 1, across a longitudinal axis of the device at its middle; and

FIGS. 4A and 4B are corresponding sectional views of the magnetic lifting device of FIG. 1, in line with a longitudinal axis of the device, in which the switchable magnet arrangement is positioned in respective off and on positions.

### DESCRIPTION OF PREFERRED EMBODIMENT

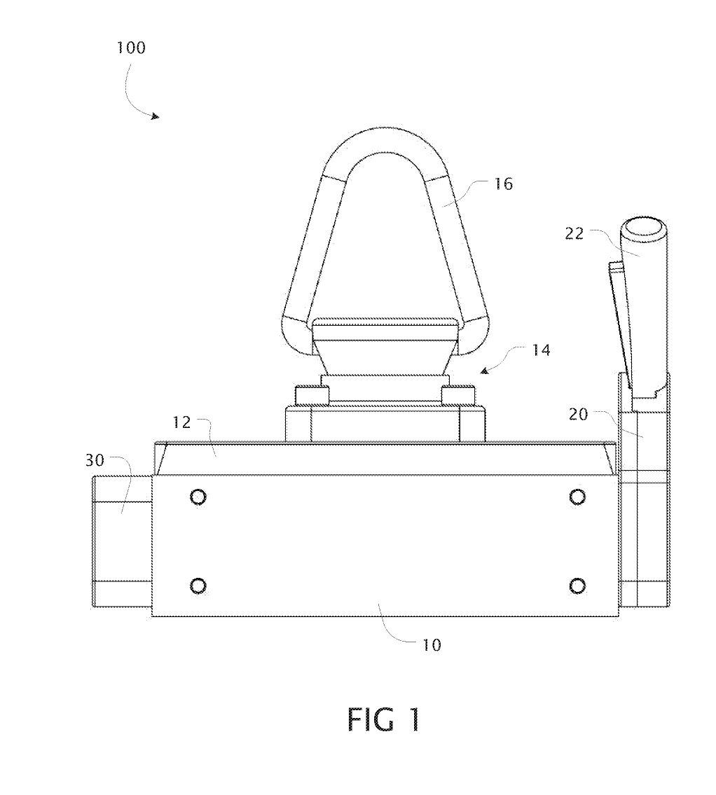

FIG. 1 depicts a side elevation along a longitudinal axis of a magnetic lifting device 100 which has a switchable magnetic arrangement in accordance with one aspect of the present invention.

As is apparent from FIG. 1, the magnetic lifting device comprises a brick-like housing block 10, of ferromagnetic material which in effect forms a housing for the switchable magnetic arrangement within a cylindrical bore 18 therein. The housing block 10 is machined from a single piece of material with very high magnetic susceptibility and low remanence and coercivity, eg 1018 steel.

An actuation assembly 20 and an axle support end assembly 30 are mounted at opposed longitudinal ends of the housing block 10. These assemblies 20, 30 interact to facilitate switching of the switchable magnetic arrangement, as described below in further detail. The magnetic lifting device 100 is turned on and off using a manually-operated handle 22, which projects from and is coupled to the actuation assembly 20.

A diamagnetic header platform 12 is mounted to the upper rim of the housing block, and in turn a lifting or coupling assembly 14 is mounted to the header 12. A lifting ring 16 threads into the lifting assembly, and is used for lifting the magnetic lifting device 100 in conventional fashion using a cable, lifting arm or the like.

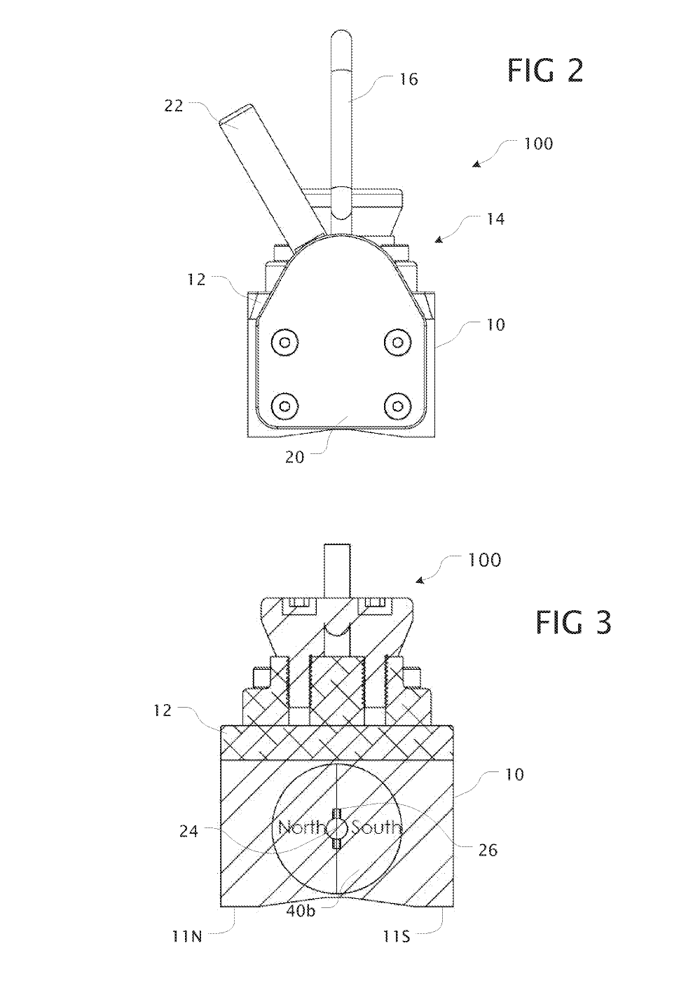

FIG. 2 depicts an elevation of the magnetic lifting device 100 of FIG. 1, viewed from a longitudinal end of the device 100, at which the actuation assembly 20, and coupled handle 22 are located.

FIG. 3 depicts a section though the middle of the device 100, which exposes the internal structure of the housing block 10. The housing block 10 has a circular bore 18 machined there through, running the length of the housing block 10.

As is apparent from FIG. 3, the housing block 10 has a narrow web 21a and 21b of block material above and below the bore 18, and a more substantial amount of material providing side walls 19a and 19b either lateral side of the bore 18. The thickness of the narrow webs 21a, 21b of material is chosen to provide sufficient mechanical integrity to the housing 10 whist at the same time being of minimum thickness such as to reduce the low magnetic reluctance ‘bridges’ these webs otherwise provide directly above and below the bore 18. In essence, the aim is to decouple magnetically the two opposed longitudinal sides 21a and 21b of the housing block 10 either side of the webs. This effect can be similarly obtained by constructing the housing block 10 of two identical pieces providing opposed longitudinal sides of the device 100, attached and jointed with strips of diamagnetic material that in effect form gaskets that achieve the same end.

At its lower face, which provides the working face for coupling the device 1000 magnetically to a work-piece (not shown), the housing block 10 is either concaved slightly towards its centre, which in effect is a centreline extending along the longitudinal axis of the housing block 10, or provided with a pair of parallel spaced apart ferromagnetic passive pole extension rails (or shoes) extending the length of the housing block 10. This concaved rebate serves to more clearly separate and focus the magnetic flux which is delivered into the working piece during magnetic coupling, and can be said, therefore, to define two working pole faces 11 along respective longitudinal sides or edges of the housing block 10.

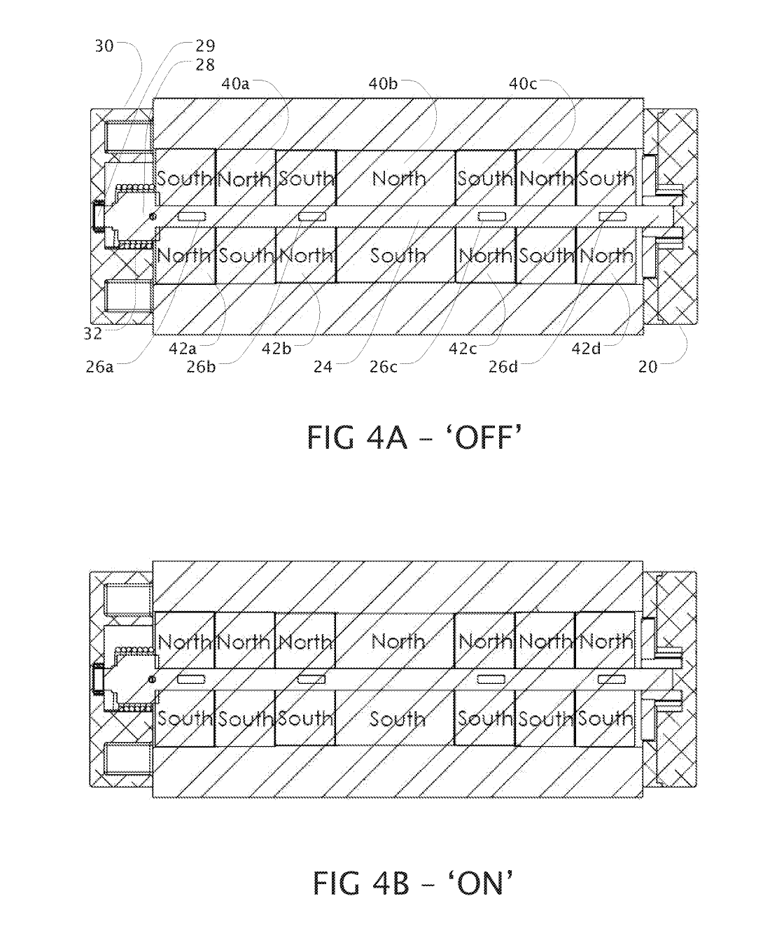

FIGS. 4A and 4B are corresponding sections through the magnetic lifting device 100, in which the device 100 is respectively switched in off and on positions.

The magnet units 40, 42 arranged within the housing block 10 are dipolar permanent magnets, preferably of a rare-earth material, which are circular disk or cylindrical in external shape. More precisely, the magnet units 40, 42 are annular bodies, as each of the magnet units 40, 42 features a central void to accommodate an actuation shaft 24.

The boundary between north and south poles is notionally along a diameter line though the centre of the magnets 40, 42. In both off and on positions, the division between the poles is approximately aligned in a common plane with the sides of the housing block 10.

The magnet units 40, 42 comprise fixed magnets 40 and rotatable magnets 42, arranged as an interleaving series in which rotatable magnets 42 alternate with fixed magnets 40. While the magnets 40, 42 are depicted as directly adjacently arranged, the magnets 40, 42 maintain a minimal, fixed gap between opposing axial end faces, and may in fact be separated by a thin sheet of anti-friction material with suitable diamagnetic properties which serves as a bearing surface between opposed faces of the magnets 40, which rotate with respect to each other.

The fixed magnet units 40 and rotatable magnet units 42 are arranged in the following particular order. Rotatable magnet units 42a, 42d are positioned at respective longitudinal ends of the housing block 10, with fixed magnet units 40a, 40c positioned directly adjacent or inboard of these rotatable magnet units 42a, 42d. Another pair of rotatable magnet units 42b, 42c are positioned directly adjacent or inboard of these fixed magnet units 40a, 40c. A fixed magnetic unit 40b is located directly between the innermost rotatable magnet units 42b, 42c, and has twice the mass of active magnetic material than the other units.

From one longitudinal end of the housing block 10 to the other longitudinal end, the ordering of magnet units is as follows: 42a, 40a, 42b, 40b, 42c, 40c, 42d. Thus four rotatable magnet units 42 are interleaved with three fixed magnet units in a strict alternating pattern, with the series of magnet units being bracketed at both ends by rotatable magnet units 42a, 42d.

As well as a central void, the rotatable magnets 42 also feature two diametrically opposed keyways (slots) extending inwardly of the central void to mate with rectangular keys 26 secured to and radially projecting from the actuation shaft 24. The keys 26 are thus received in the corresponding keyways to secure the rotatable magnets 42 to the actuation shaft 24 for synchronous rotation with it.

The fixed magnets 40 are held in fixed location and orientation within the housing block 10, by any suitable means, such as a force fit, but preferably using a keyed force fit with or without additional adhesive to secure the fixed magnets and prevent magnetically induced rotation with the actuation shaft which is made of any suitable diamagnetic material, including bras.

The fixed magnets 40a, 40b, 40c and rotatable magnets 42a to 42d are of the same general form factor, as depicted, though the rotatable magnets 42 will be of slightly smaller diameter to allow for free rotation with the bore 18 of the housing block 10. Also, a central fixed magnet 40b is selected to be greater width than adjacent fixed and rotatable magnets 40, 42, ie have double the active material mass as that of the rotatable magnets 42 in order to provide for magnetic symmetry between all permanent magnet units 40, 42 of the magnetic assembly.

As described above, FIG. 4A depicts the magnets 40, 42 in the ‘off’ position, and FIG. 4B depicts the magnets 40, 42 in an cony position.

The off position, as depicted in FIG. 4A, has alternating fixed and rotatable magnets 40, 42 arranged with opposed polarity. The respective magnetic fields generated by the magnets 40, 42 in the off position are opposed, and consequently act to cancel each other (thus the need for the total of active magnetic mass of rotatable vs fixed magnets to be the same). The net resulting magnetic field thus approaches zero, or at least a very small net value relative to the gross value of the magnetic fields of the magnets 40, 42.

More particularly, opposite poles of the fixed magnets 40 and rotatable magnets 42 are arranged along opposite sides of the device 100, as depicted in FIG. 4A. Thus, for example, the N pole of rotatable magnet 42a, is rotationally located at one side of the housing block 10, and directly adjacent is the S pole of fixed magnet 40a, then the N pole of rotatable magnet 42b, and so on along the longitudinal axis of the housing block 10 to the N pole of the rotatable magnet 42d. As the magnets 40, 42 are dipolar, the reverse pattern applies on the opposite side of the housing block 10.

The on position, as depicted in FIG. 4B, has alternating fixed and rotatable magnets 40, 42 arranged with aligned polarity. The respective magnetic fields generated by the magnets 40, 42 in the on position are aligned, and consequently act to reinforce each other. The net resulting magnetic field extending into the adjacent housing wall is thus a substantial value, reflective of the contribution of each of individual magnetic fields of the magnets 40, 42.

More particularly, common poles of the fixed magnets 40 and rotatable magnets 42 are arranged along opposite sides of the device 100, as depicted in FIG. 4B. Thus, the N poles of the magnets 40, 42 are positioned along one side of the housing block 10, and the S poles are positioned along the opposite side of the housing block 10.

The on position, owing to the common orientation of shared poles of the magnets 40, 42, generates a substantial amount of magnetic field through the working pole faces 11. The concaved recess provided between the working pole faces 11 provides a clearance from the workpiece, and serves to concentrate the magnetic flux supplied by the switchable magnetic arrangement, or in other words, the magnet units 40, 42, to the respective working pole faces 11N, 11S for delivery to the ferromagnetic workpiece.

When the device 100 is activated or switched to the on position, the working pole faces 11 transmit a substantial magnetic flux via alignment of the N poles of the fixed and rotatable magnet 40, 42 along the longitudinal side of the housing block above the ‘north’ working pole face 11N, and the corresponding alignment of the S poles of the fixed and rotatable magnet 40, 42 along the longitudinal side of the housing block above the ‘south’ working pole face 11S.

Consequently, a ferromagnetic work-piece can be readily secured against the working faces 11 when the device 100 is on, as the workpiece provides a low reluctance path for the magnetic field, compared to the surrounding air. The magnetic flux delivered between the working pole faces 11 is thus shunted through the workpiece, which completes a magnetic circuit by virtue of offering a low reluctance path compared to the surrounding air. The workpiece is thus securely gripped while the device is on, and the device 100 is switched off to release the workpiece, typically after it has been moved using the device 100.

The device 100 can be switched between off and on positions by any suitable actuating means. The preferred actuating means involves the actuation assembly 20, co-operating end assembly 30, actuation shaft 24, which is retained at and extends between the actuation assembly 20 and the end assembly 30, and external handle 22 used to initiate switching.

The actuation shaft 24 is retained in journalled fashion at one end of the housing block 10 by the actuation assembly 20, and at the other end of the housing block 10 by the end assembly 20. The actuation shaft 24 terminates with a shaft head 28, which is of greater diameter than a working diameter of the actuation shaft 24. The shaft head 28 serves to retain the actuation shaft 24 within the end assembly 20, and locate the actuation shaft against the housing block 10. An end rod 29 projecting from the shaft head 28 is used in conjunction with an associated bearing arrangement to secure the actuation shaft 24 in the end assembly 30, and ensure that the shaft is centred, and freely rotates.

The shaft head 28 has a return spring 32 coupled to the shaft head 28 and the end assembly 30, and disposed around the periphery of the shaft head 28. The return spring 32 serves to provide a counterforce to angular displacement of the shaft 24 via the handle 22 during operation, which provides a smooth operation during displacement of the handle 22.

The handle 22 is a simple round cross-section bar projecting from the actuation assembly 20, which is mounted at one end of the housing block 10. The handle 22 has a sweep or angular range of 45°, and the actuation assembly 20 incorporates stops that define the extremities of the sweep of the handle and thus the respective off and on positions, which are accordingly marked by visual indicia. Positive force fit elements can be used to provide tactile feedback through the handle that the off or on position is located and engaged, which also prevents the handle 22 and thus the magnets 40, 42 from slipping from the selected position.

The handle 22 is integral with an input shaft that couples with a 4:1 gear ratio multiplier to translate the restricted sweep of the handle 22 to a half revolution (that is, 180°) of the actuation shaft 24 required to transition between the off and on positions.

While a variety of gearing arrangements can be adopted to achieve the required ratio, a simple gear train is preferred, for example one in which the input shaft integral with the handle 22 is coupled to a ring gear, and the actuation shaft 24 is coupled to a sun gear. As is usual, a ring gear is coupled to the sun gear via planetary gears which mesh with and between the ring gear and sun gear.

A sweep of greater or less than 45° may also be used, with a compensating change in the gearing arrangement that ensures a half-revolution at the actuation shaft 24 for switching between off and on positions. For example, a sweep of 90° may be used in conjunction with a 2:1 gearing arrangement. Also, a range of different types of gearing arrangement may also be used as required.

Furthermore, a gearing arrangement may be dispensed with altogether and an alternative form of handling mechanism used for switching the device 100, such as a direct drive rotating handle that can rotate through a full revolution, or at least a half-revolution.

Various other means of assisted switching could also be adopted, for example, with actuating arrangements driven by external electrical, hydraulic or pneumatic source of power, and using electrical motors, or hydraulic or pneumatic circuits.

Also, an actuation shaft is not specifically needed, and instead switching could be achieved using a rotary bar coupled to each of the rotatable magnets by rods that switches the rotatable magnets in common alignment.

Furthermore, while one particular form of magnetic unit is described and depicted in the accompanying drawings, a broad range of alternative magnet units could also be adopted. There is for example no overwhelming requirement that the magnets be circular or annular in shape. A variety of other shaped dipolar magnets could be used, for example having bar-shaped magnets, bow tie-shaped magnets or chevron-shaped magnets. Peripheral edges of such magnets may be curved to allow for close clearance as well as free rotation within the housing block.

The preferred embodiment described and depicted characterises the magnet units as fixed and rotatable, though alternative implementations are possible in fact in which two sets of magnets both rotate with respect to the housing block and each other, provided that the respective poles of the two sets of magnet units are in opposed arrangement in an off position, and aligned arrangement in an on position.

As an example, on could envisage an arrangement in which alternating magnet units have their opposed poles arranged vertically rather than horizontally in the off position. That is, an upper part of the housing block has a sequence of N-S-N etc poles, while a lower part of the housing block has a sequence of S-N-S etc poles. In this case, the device would be switching to an aligned orientation (in the on position) by rotating the two sets of magnet units in opposite quarter-revolutions so that all N poles are arranged to one side of the housing block, and all S poles to the opposite side of the housing block.

Comparative testing of the MLAY 600x4 lifter, and a comparable lifter constructed in accordance with a preferred embodiment of the present invention indicates particular advantages that are attributable to the lay out of magnets within the lifter housing, as regards residual magnetisation left imprinted on a ferromagnetic work-piece (plate). In particular, the lifter 100 is found to generate less residual magnetisation (remanence) on a steel plate compared to the MLAY 600x4 architecture. Moreover, while the magnitude of the residual magnetisation in the steel plate is lower, the distribution of residual magnetisation through the plate is more even, with less pronounced maxima, along the footprint of the housing and its adjacent zones. These particular advantages are believed to be attributable to the unique architecture of the lifter 100.

More specifically, the MLAY 600×4 is found to provide local maxima in residual magnetic fields at the corners of the pole shoes, which follows the patterns of the penetrating field delivered by the pole shoes in the MLAY 600×4.

By contrast, the described lifter 100 also delivers a similar pattern of penetrating field, yet surprisingly leaves a more consistent and lower residual magnetic field, with less pronounced maxima adjacent the middle of the outer edges of the pole faces.

The placement and motion of the magnets within the housing block of the lifter 100 appears to be the source of this more gradual variation in residual magnetic field imprinted upon the workpiece.

More particularly, bracketing the alternating series of fixed and rotatable magnet units 40, 42 with rotatable magnet units 42a, 42d at respective ends of the housing block 10 is believed to assist in this regard. When the lifter 100 is cycled to the off position, the rotatable magnet units 42a, 42d positioned at respective longitudinal ends of the housing block 10 can be expected to generate a small net negative field. This is because the field generated by the rotatable magnet units 42a, 42d is not entirely cancelled by the adjacent fixed magnet units 40a, 40c. The net magnetic field may be just great enough to reverse some residual magnetic field remnant in the work-piece near to the point of remanence, while not being as strong as to push the material to saturation in the opposite direction.

Terms such as upper, lower, longitudinal, width, horizontal, vertical and similar relative terms used in the foregoing description are used to facilitate understanding of relational arrangement and orientation of component parts and features of the lifting device described herein, also in use. Unless dictated otherwise from the context of use of such terms, there is no intention for such terms to impart a limitation on features to which such relate.

A skilled person in the relevant art will also appreciate that whilst the lifting device illustrated in the accompanying drawings uses permanent magnet units as the magnetic flux source, a smaller or larger number of such units can be employed and the housing and actuation mechanism to switch the device would be modified accordingly.

1. A magnetic device, in particular for holding or lifting ferromagnetic workpieces and objects, comprising: a housing block; a switchable magnet arrangement comprising a plurality of individual permanent magnet units accommodated within the housing block; and a pair of passive, ferromagnetic pole extension members integral with or securable to the housing block and magnetically separated from each other, for transferring magnetic flux supplied by the switchable magnetic arrangement to a ferromagnetic object in contact with a working face of the housing block, wherein the switchable magnetic arrangement comprises a series of rotatable and fixed permanent magnet units arranged in interleaving relationship along a longitudinal axis of the housing block in which a fixed one of the magnet units is adjacent and follows a rotatable one of the magnet units, wherein the fixed units are arranged to continuously impart a N-polarity to one of the pair of pole extension members and a S-polarity to the other one of the pole extension members, wherein the rotatable units are arranged to impart a N- or a S-polarity to the pair of pole extension members as a function of a rotational state of the rotatable magnet units with respect to the fixed units, wherein the device is switchable by rotation of the rotatable units between an ‘off’ position in which the respective magnetic fields of adjacent fixed and rotatable units extending into the pole extension members are opposed and substantially cancel each other, and an ‘on’ position in which the respective magnetic fields of adjacent fixed and rotatable units extending into the pole extension members are aligned and substantially reinforce each other, whereby in the on position the N- and the S-poles poles of all the magnet units are respectively arranged along opposed longitudinal sides of the housing block and the magnetic device will magnetically attach to a ferromagnetic work-piece or object by virtue of magnetic flux passing between the permanent magnet units through the pole extension members at the working face and the work piece or object, and in the off position will detach from the ferromagnetic workpiece by virtue of magnetic flux supplied by the permanent magnet units being substantively confined within the switchable magnetic arrangement.

2. A magnetic device, comprising: a housing block with a cavity extending along a longitudinal axis thereof and having at least two ferromagnetic wall portions along a longitudinal extension of the housing block that are substantially magnetically separated from one another; a switchable permanent magnet arrangement accommodated within the cavity of the housing block for magnetically interacting with the ferromagnetic wall portions; and a working face extending along one or more of an exterior longitudinal side, top or bottom face of the housing at the least two magnetically separated wall portions of the housing block, the working face devised for attaching to a ferromagnetic object for magnetically securing the object in releasable manner to the device, characterised in that the switchable permanent magnetic arrangement comprises a plurality of permanent magnet units in successive arrangement along and traversed by a rotor axle extending within the cavity, wherein all permanent magnet units exhibit a N-S pole pair, wherein alternate ones of the successively arranged permanent magnet units are secured to the axle for rotation therewith whereas the remainder are traversed by the axle and held stationary within the cavity, wherein the stationary permanent magnet units are held such that all N-S pole pairs are oriented in the same direction and impart opposite N-S polarities to the at least two ferromagnetic wall portions of the housing, and wherein the rotatable permanent magnet units are secured to the rotor axle in such manner that their N-S pole pairs may be brought in and out of parallel and anti-parallel alignment with the N-S pole pair of the adjoining stationary permanent magnet units, indexing of N-S pole pairs of successive magnet units being such that the device is switchable between an on, magnetic flux delivering position and an off, magnetic flux shunting position, by rotating the axle-secured magnet units within the cavity with respect to the interleaved stationary magnet units.

3. A magnetic device according to claim 1, wherein the magnet units consist of diametrically magnetized, dipolar cylindrical or circular disk-like plates with a central through hole extending there through, alternate magnet units along the longitudinal axis being secured to the axle and the housing block, respectively.

4. A magnetic device according to claim 1, wherein the alternating series of fixed magnet units and rotatable magnet units end with rotatable magnet units positioned near or at respective longitudinal ends of the housing block.

5. A magnetic device according to claim 1, further comprising an actuating shaft that engages and rotates the rotatable magnet units in synchronous and aligned rotation and passes through the fixed magnet units, to effect switching of the rotatable magnet units between the off and on positions.

6. A magnetic device according to claim 5, wherein the rotatable magnet units are keyed to the actuating shaft, and wherein the actuating shaft is devised for rotation though a half-revolution to switch between the on and off positions of the magnetic device.

7. A magnetic device according to claim 6, further comprising an actuation assembly and an end assembly attached to the housing block and disposed at opposite longitudinal ends thereof for coupling and retaining the actuating shaft centred within the cavity.

8. A magnetic device according to claim 7, further comprising a handle for switching between the on and off positions, which is attached to the shaft via the actuating assembly.

9. A magnetic device according to claim 8, wherein the actuating assembly comprises a gearing assembly coupling the handle with the actuating shaft.

10. A magnetic lifting device according to claim 2, further comprising a pair of parallel spaced apart, ferromagnetic passive pole rails at the working face(s).

11. A magnetic device according to claim 1, further comprising a lifting assembly or elements which are mounted to the housing block and arranged to cooperate with a crane, rig or similar apparatus for lifting objects whilst magnetically secured to the device.

12. A magnetic device according to claim 1, wherein the permanent magnet units are located directly adjacent each other along the longitudinal axis of the housing block.

13. A magnetic device for lifting and/or holding ferromagnetic work-pieces comprises a ferromagnetic housing block and a switchable magnet arrangement accommodated within a cavity of the housing block, the housing is formed to define two longitudinal sides that are substantially decoupled magnetically from one another, the switchable magnet arrangement comprising a plurality of cylindrical, and in particular annular-shaped permanent dipole magnets arranged in sequence along a longitudinal axis of the housing block between the two housing sides, wherein the dipole magnet comprise fixed permanent dipole magnets interleaved along the axis with rotatable permanent dipole magnets, wherein an actuation shaft penetrates and extends through the fixed and rotatable dipole magnets and keys with the rotatable dipole magnets to impart rotation with respect to the fixed dipole magnets about the longitudinal axis of the housing block, wherein the magnetic device can be switched between an off position in which respective magnetic fields of adjacent ones of the dipole magnets are opposed and substantially cancel each other, and an on position in which respective magnetic fields of all the dipole magnets are aligned in the same orientation and substantially reinforce each other such as to jointly polarise the two longitudinal sides of the housing block with opposite N and S-polarities.

14. A magnetic device according to claim 2, wherein the magnet units consist of diametrically magnetized, dipolar cylindrical or circular disk-like plates with a central through hole extending there through, alternate magnet units along the longitudinal axis being secured to the axle and the housing block, respectively.

15. A magnetic device according to claim 2, wherein the alternating series of fixed magnet units and rotatable magnet units end with rotatable magnet units positioned near or at respective longitudinal ends of the housing block.

16. A magnetic device according to claim 3, wherein the alternating series of fixed magnet units and rotatable magnet units end with rotatable magnet units positioned near or at respective longitudinal ends of the housing block.

17. A magnetic device according to claim 2, further comprising a lifting assembly or elements which are mounted to the housing block and arranged to cooperate with a crane, rig or similar apparatus for lifting objects whilst magnetically secured to the device.

18. A magnetic device according to claim 2, wherein the permanent magnet units are located directly adjacent each other along the longitudinal axis of the housing block.
